(19) United States
(12) Patent Application Publication
(10) Pub. No.: US 2014/0150440 A1
(43) Pub. Date: Jun. 5, 2014

(54) GAS TURBINE ENGINE WITH A LOW SPEED SPOOL DRIVEN PUMP ARRANGEMENT

(71) Applicant: UNITED TECHNOLOGIES CORPORATION, Hartford, CT (US)

(72) Inventors: Gabriel L. SUCIU, Glastonbury, CT (US); Christopher M. DYE, San Diego, CA (US)

(73) Assignee: UNITED TECHNOLOGIES CORPORATION, Hartford, CT (US)

(21) Appl. No.: 13/705,462

(22) Filed: Dec. 5, 2012

(51) Int. Cl. F02C 7/236

(52) U.S. Cl. CPC F02C 7/236
USPC 60/772; 60/726

(57) ABSTRACT

A gas turbine engine includes, among other things, a propulsion assembly situated to rotate about an engine central axis. Operation of the propulsion assembly requires a first amount of fluid during a first operating condition and a second, greater amount of the fluid during a second operating condition. A first pump is operatively associated with a low speed spool that rotates with a low pressure turbine. The first pump has a first fluid delivering capacity corresponding to at least the first amount. A second pump has a second fluid delivering capacity configured to correspond to at least a difference between the first amount and the second amount. The first pump provides the fluid for propulsion assembly during the first and second operating conditions and the second pump provides the fluid for propulsion assembly operation only during the second operating condition.

### BACKGROUND

A gas turbine engine typically includes a fan section, a compressor section, a combustor section and a turbine section. Air entering the compressor section is compressed and delivered into the combustor section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

A gas turbine engine typically requires different amounts of fuel during different operating conditions. For example, more fuel is needed during aircraft takeoff than during cruising conditions. A pump typically provides the same amount of fuel flow during each of those conditions. When less fuel is needed, the excess is recirculated within the fuel delivery system. Recirculating fuel requires additional components and introduces additional heat management issues.

### SUMMARY

A gas turbine engine according to an exemplary aspect of the present disclosure includes, among other things, a propulsion assembly including at least a high pressure turbine and a low pressure turbine. The turbines are situated to rotate about an engine central axis. Operation of the propulsion assembly requires at least one fluid including requiring a first amount of the fluid during at least a first operating condition and a second, greater amount of the fluid during at least a second operating condition. A low speed spool is configured to rotate about the engine central axis with the low pressure turbine. A first pump is operatively associated with the low speed spool such that operation of the first pump is dependent on rotation of the low speed spool, the first pump having a first fluid delivering capacity configured to correspond to at least the first amount. A second pump has a second fluid delivering capacity configured to correspond to at least a difference between the first amount and the second amount. The first pump provides the fluid for propulsion assembly operation during the first and second operating conditions and the second pump provides the fluid for propulsion assembly operation only during the second operating condition.

In a further non-limiting embodiment of the foregoing gas turbine engine, the second pump is inactive during the first operating condition.

In a further non-limiting embodiment of either of the foregoing gas turbine engines, a controller is configured to determine at least one of the operating condition of the propulsion assembly or an amount of the fluid needed and control the second pump to provide a corresponding amount of the fluid to the propulsion assembly.

In a further non-limiting embodiment of any of the foregoing gas turbine engines, the fluid comprises fuel.

In a further non-limiting embodiment of any of the foregoing gas turbine engines, the fluid comprises a lubricant.

In a further non-limiting embodiment of any of the foregoing gas turbine engines, the second pump is driven by a power element distinct from the low speed spool.

In a further non-limiting embodiment of any of the foregoing gas turbine engines, the power element comprises an electric motor.

In a further non-limiting embodiment of any of the foregoing gas turbine engines, the second fluid delivery capacity is lower than the first fluid delivery capacity.

In a further non-limiting embodiment of any of the foregoing gas turbine engines, the gas turbine engine assembly comprises a power extraction module that is an interface between the low speed spool and the first fluid pump.

In a further non-limiting embodiment of any of the foregoing gas turbine engines, the gas turbine engine comprises at least one other pump operatively associated with the power extraction module such that the other pump is driven based on rotation of the low speed spool.

A method according to an exemplary aspect of the present disclosure is useful for operating a gas turbine engine that includes a propulsion assembly having at least a high pressure turbine and a low pressure turbine situated to rotate about an engine central axis. The operation of the propulsion assembly requires at least one fluid including a first amount of the fluid during at least a first operating condition and a second, greater amount of the fluid during at least a second operating condition. The method includes, among other things, driving a first pump using rotation of a low speed spool configured to rotate about the engine central axis with the low pressure turbine for providing the fluid for propulsion assembly operation during the first and second operating conditions. The method includes driving a second pump only during the second operating condition for providing the fluid for propulsion assembly operation with the first pump. An amount of the fluid provided by the second pump corresponds to a difference between the first amount and the second amount.

A further non-limiting embodiment of the foregoing method includes inactivating the second pump during the first operating condition.

A further non-limiting embodiment of either of the foregoing methods includes determining at least one of the operating condition of the propulsion assembly or an amount of the fluid needed and controlling the second pump to provide a corresponding amount of the fluid to the propulsion assembly.

In a further non-limiting embodiment of any of the foregoing methods, the fluid comprises fuel.

In a further non-limiting embodiment of any of the foregoing methods, the fluid comprises a lubricant.

A further non-limiting embodiment of any of the foregoing methods includes driving the second pump using a power element distinct from the low speed spool.

In a further non-limiting embodiment of any of the foregoing methods, the power element comprises an electric motor.

In a further non-limiting embodiment of any of the foregoing methods, the first pump has a first fluid delivering capacity configured to correspond to at least the first amount and the second pump has a lower, second fluid delivering capacity configured to correspond to at least a difference between the first amount and the second amount.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 is a schematic view of an example gas turbine engine.

FIG. 2 schematically illustrates selected portions of an example gas turbine engine fluid delivery arrangement.

FIG. 3 schematically illustrates an example fuel delivery arrangement.

FIG. 4 schematically illustrates an example lubricant delivery arrangement.

### DETAILED DESCRIPTION

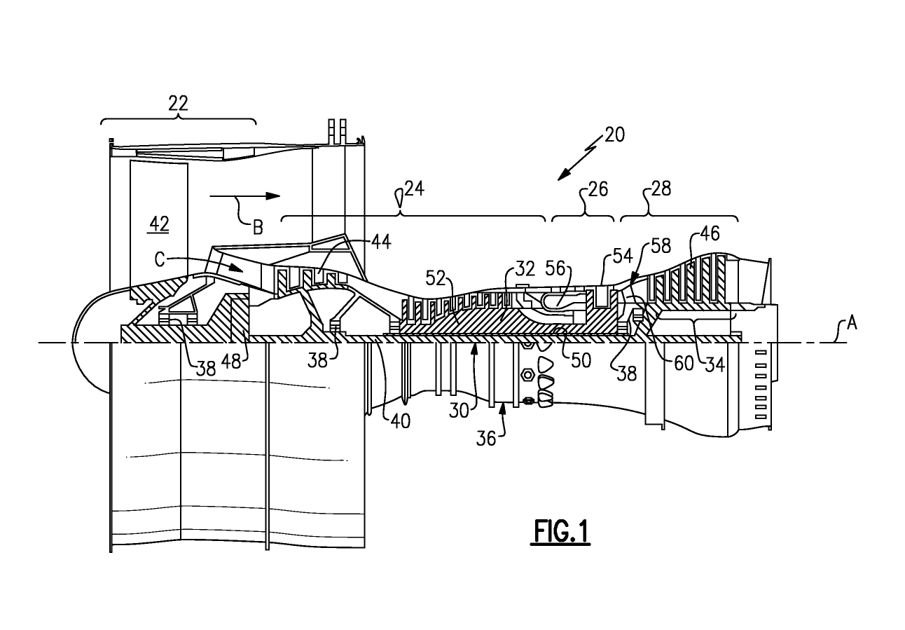

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to the combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts disclosed in this description and the accompanying drawings are not limited to use with turbofans as the teachings may be applied to other types of turbine engines, such as a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used in this description, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 and sets airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption ('TSFC')”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram °R)/518.7)⁰⁵]. The “Low corrected fan tip speed”, according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

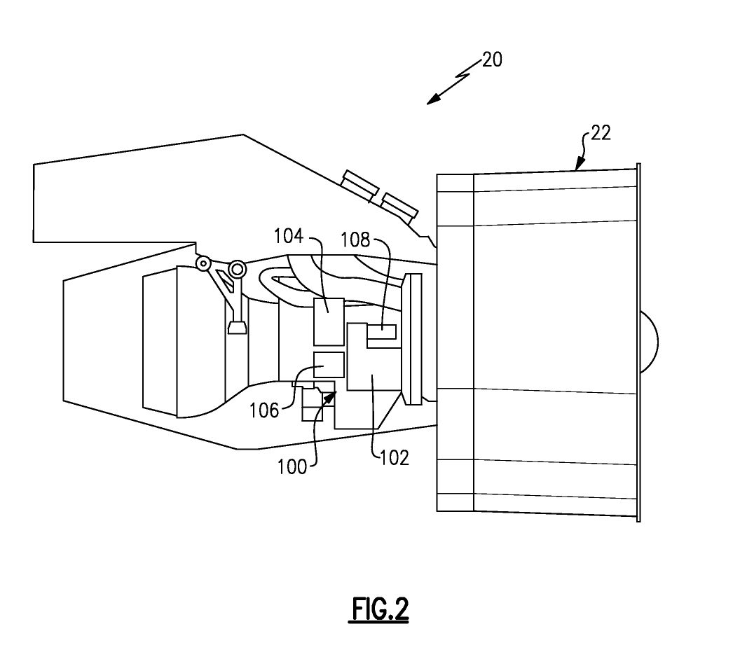

FIG. 2 schematically illustrates selected portions of the gas turbine engine 20. A fluid delivery system 100 includes a low speed spool power extraction module 102 that is associated with the low speed spool 30 (FIG. 1). In one example, the low speed spool power extraction module 102 includes a variable-speed transmission with multiple takeoffs for driving several devices. A first fuel pump 104 is driven based upon rotation of the low speed spool 30. The first fuel pump 104 is operatively associated with the power extraction module 102 to provide an appropriate input speed and torque to the first fuel pump 104. The power extraction module 102 is an interface between the low speed spool 30 and the first fuel pump 104. A first lubricant pump 106 is associated with the power extraction module 102. The first lubricant pump 106 is driven responsive to rotation of the low speed spool 30. In this example, a hydraulic pump 108 is also driven based upon rotation of the low speed spool 30.

Utilizing a low speed spool power extraction module 102 for driving the pumps 104-108 can decrease thrust-specific fuel consumption compared to arrangements that attempt to drive a pump based upon rotation of the high speed spool. In a geared turbo fan architecture, the low speed spool has additional power capabilities that have less effect on engine efficiency compared to a smaller sized high speed spool.

FIG. 3 schematically illustrates a fuel delivery arrangement for providing fuel from a supply 120 to appropriate portions of the engine, such as an engine nozzle or manifold. The engine requires a first amount of fuel during a first operating condition and a second, larger amount of fuel during a second operating condition. In this example, the first fuel pump 104 provides fuel to the manifold 122 during the first operating condition. The first fuel pump 104 has a fuel delivery capacity corresponding to at least the amount of fuel needed during the first operating condition. In one example, the first operating condition corresponds to the engine operating at a cruise setting.

The engine requires a second, larger amount of fuel during the second operating condition, such as engine start. The example of FIG. 3 includes a second fuel pump 130 for providing fuel during the second operating condition. In this example, the second fuel pump 130 has a fuel delivery capacity corresponding to an amount that is at least the difference between the amount of fuel required during the first operating condition and the amount of fuel required during the second operating condition. When the first fuel pump 104 and the second fuel pump 130 operate together, the second amount of fuel is provided to the manifold 122 for the second operating condition.

In the illustrated example, the second fuel pump 130 is driven by an electric motor 132. A controller 134 controls operation of the electric motor 132 and a valve 136 for selectively controlling the amount of fuel provided to the manifold 122 at any given time. The controller 134 is programmed to recognize when the first operating condition exists or the second operating condition exists and appropriately controls the valve 136 and the electric motor 132 for controlling whether the second fuel pump 130 is used for providing fuel to the manifold 122.

In the example of FIG. 3, the second pump 130 may also be useful for supplementing the amount of fuel delivered by the pump 104 as schematically shown at 138. For example, the second fuel pump 130 may be used as a boost for actuator flow. The controller 134 is suitably programmed to provide such operation in example embodiments that include this feature.

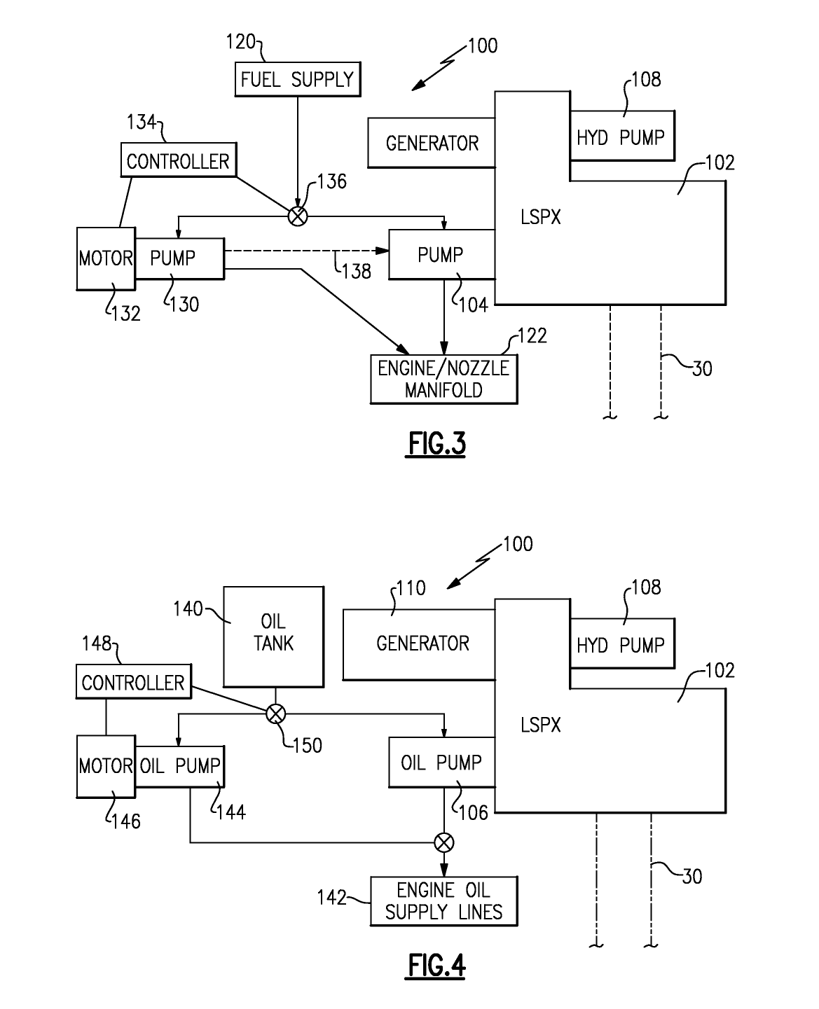

FIG. 4 schematically shows a lubricant delivery arrangement in which the first oil pump 106 is used for supplying lubricant from a reservoir 140 to supply lines 142, which are used in a known manner to deliver lubricant to engine components. The engine 20 requires less lubricant during a first operating condition compared to the amount of lubricant required during a second operating condition. In one example, the first operating condition corresponds to the engine operating at cruise. The first oil pump 106 has a lubricant delivery capacity corresponding to at least the amount of lubricant required during the first operating condition.

A second oil pump 144 provides lubricant to the supply lines 142 during the second operating condition in addition to the amount of lubricant provided by the first oil pump 106. In this example, the second oil pump 144 is driven by an electric motor 146. A controller 148 controls the motor 146 and a valve 150 depending on whether the engine 20 is operating under the first operating condition or the second operating condition. The second oil pump 144 has a lubricant delivery capacity corresponding to at least a difference between the amount of lubricant required during the second operating condition and the amount of lubricant required during the first operating condition.

The illustrated example arrangements allow for using individual pumps that are smaller than pumps typically included with gas turbine engines for fuel or oil delivery. Using smaller pumps allows for associating those pumps with the low speed spool 30 instead of having to drive those pumps from the high speed spool. Using smaller pumps provides the advantage of requiring less space for those components. Additionally, less power is extracted from engine operation to operate the pumps, which leaves more power for propulsion of an aircraft or other power requirements. For example, instead of having to size a single pump for delivering fuel or oil so that it is capable of meeting the demands of the second operating condition, which occurs during a relatively limited portion of the engine operation time, a smaller first fuel pump 104 or first oil pump 106 may be utilized. Including a second pump to supplement the fluid delivery requirements during the second operating condition allows for the first pump 104 or 106 to operate during the first operating condition while leaving the second pump 130 or 144 dormant during that condition if desired.

Another feature of the illustrated arrangement is that it reduces the requirement for recirculating fuel or oil during cruise conditions. Conventional arrangements include such recirculation which also involves heat rejection requirements. The illustrated arrangement in which fluid delivery requirements are split between two different pumps provides additional efficiencies during engine operation.

The preceding description is illustrative rather than limiting in nature. Variations and modifications to the disclosed examples may become apparent to those skilled in the art. The scope of legal protection can only be determined by studying the following claims.

We claim:

1. A gas turbine engine, comprising:
a propulsion assembly including at least a high pressure turbine and a low pressure turbine, the turbines being situated to rotate about an engine central axis, operation of the propulsion assembly requiring at least one fluid including requiring a first amount of the fluid during at least a first operating condition and a second, greater amount of the fluid during at least a second operating condition;
a low speed spool configured to rotate about the engine central axis with the low pressure turbine;
a first pump that is operatively associated with the low speed spool such that operation of the first pump is dependent on rotation of the low speed spool, the first pump having a first fluid delivering capacity configured to correspond to at least the first amount; and
a second pump having a second fluid delivering capacity configured to correspond to at least a difference between the first amount and the second amount;
the first pump providing the fluid for propulsion assembly operation during the first and second operating conditions and the second pump providing the fluid for propulsion assembly operation only during the second operating condition.

2. The gas turbine engine of claim 1, wherein the second pump is inactive during the first operating condition.

3. The gas turbine engine of claim 1, comprising a controller configured to:
determine at least one of the operating condition of the propulsion assembly or an amount of the fluid needed; and
control the second pump to provide a corresponding amount of the fluid to the propulsion assembly.

4. The gas turbine engine of claim 1, wherein the fluid comprises fuel.

5. The gas turbine engine of claim 1, wherein the fluid comprises a lubricant.

6. The gas turbine engine of claim 1, wherein the second pump is driven by a power element distinct from the low speed spool.

7. The gas turbine engine of claim 6, wherein the power element comprises an electric motor.

8. The gas turbine engine assembly of claim 1, wherein the second fluid delivery capacity is lower than the first fluid delivery capacity.

9. The gas turbine engine assembly of claim 1, comprising a power extraction module that is an interface between the low speed spool and the first fluid pump.

10. The gas turbine engine assembly of claim 9, comprising at least one other pump operatively associated with the power extraction module such that the other pump is driven based on rotation of the low speed spool.

11. A method of operating a gas turbine engine that includes a propulsion assembly including at least a high pressure turbine and a low pressure turbine, the turbines being situated to rotate about an engine central axis, operation of the propulsion assembly requiring at least one fluid including a first amount of the fluid during at least a first operating condition and a second, greater amount of the fluid during at least a second operating condition, comprising the steps of:
driving a first pump using rotation of a low speed spool configured to rotate about the engine central axis with the low pressure turbine for providing the fluid for propulsion assembly operation during the first and second operating conditions; and
driving a second pump for providing the fluid for propulsion assembly operation with the first pump only during the second operating condition, an amount of the fluid provided by the second pump corresponding to a difference between the first amount and the second amount.

12. The method of claim 11, comprising inactivating the second pump during the first operating condition.

13. The method of claim 11, comprising
determining at least one of the operating condition of the propulsion assembly or an amount of the fluid needed; and
controlling the second pump to provide a corresponding amount of the fluid to the propulsion assembly.

14. The method of claim 11, wherein the fluid comprises fuel.

15. The method of claim 11, wherein the fluid comprises a lubricant.

16. The method of claim 11, comprising driving the second pump using a power element distinct from the low speed spool.

17. The method of claim 16, wherein the power element comprises an electric motor.

18. The method of claim 11, wherein
the first pump has a first fluid delivering capacity configured to correspond to at least the first amount; and
the second pump has a lower, second fluid delivering capacity configured to correspond to at least a difference between the first amount and the second amount.
